(19) United States
(12) Patent Application Publication
(10) Pub. No.: US 2021/0303616 A1
(43) Pub. Date: Sep. 30, 2021

(54) IMAGE FILE GENERATION APPARATUS, IMAGE FILE GENERATION METHOD, AND COMPUTER-READABLE STORAGE MEDIUM

(71) Applicant: CANON KABUSHIKI KAISHA, Tokyo (JP)

(72) Inventor: Masanori Fukada, Tokyo (JP)

(21) Appl. No.: 17/345,004

(22) Filed: Jun. 11, 2021

Related U.S. Application Data
(63) Continuation of application No. PCT/JP2019/043118, filed on Nov. 1, 2019.

(30) Foreign Application Priority Data
Dec. 18, 2018 (JP) 2018-236722

(51) Int. Cl. G06F 16/583; G06F 16/51; G06F 16/16; G06F 16/58

(52) U.S. Cl. CPC G06F 16/5846; G06F 16/5866; G06F 16/164; G06F 16/51

(57) ABSTRACT

An image file generation apparatus for storing one or more images in an image file according to a predetermined image file format, the apparatus obtains a plurality of pieces of metadata to be stored in the image file, groups the plurality of pieces of metadata by a type of the metadata, and stores, in the image file, the metadata that has been grouped.

### CROSS-REFERENCE TO RELATED APPLICATIONS

This application is a. Continuation of International Patent Application No. PCT/JP2019/043118, filed Nov. 1, 2019, which claims the benefit of Japanese Patent Application No. 2018-236722, filed Dec. 18, 2018, both of which are hereby incorporated by reference herein in their entirety.

### BACKGROUND OF THE INVENTION

### Field of the Invention

The present invention relates to a technique for storing one or more pieces of image data in an image file.

### Background Art

MPEG (Moving Pictures Experts Group) is developing a standard for storing a single still image, multiple still images, or an image sequence (such as a burst of still images) in a single file. This standard is called HEIF (High Efficiency image File Format), and makes it possible to exchange, edit, and display images and image sequences. HEIF is a storage format that has been extended based on tools defined in the ISO Base Media File Format (ISOBMFF). HEIF is in the process of being standardized under the name “Image File Format” in ISO/IEC 23008-12. HEIF also defines a normative structure including metadata, methods for associating metadata with images, and structures of metadata in particular formats. PTL 1 describes storing a derivative image in an HEIF-compliant image file.

On the other hand, image generating apparatuses having image generating functions, such as cameras, smartphones, and the like, have a wide variety of functions in recent years, and are capable of generating not only the shooting date/time, image size, and image quality, but also various information such as information on the time of shooting and metadata of captured image data. For example, diverse types of information associated with image data, such as location information on where the image was taken, information identifying a subject or scene in the image data, an image capturing mode used at the time of shooting, and the like are generated along with the image data. This information pertaining to the image data can be stored in an HEIF file as metadata.

### CITATION LIST

### Patent Literature

PTL 1: US-2016-371265

When two or more images among multiple images stored in an image file (e.g., an HEIF file) according to a predetermined image format correspond to common metadata, it has been difficult to process those images efficiently. In other words, even if the same metadata corresponds to two or more images stored in a HEIF file, the metadata has been stored for each image. Accordingly, a device processing the HEIF file has not been able to confirm that the metadata of each image is common without checking the metadata of each image and configuration information thereof in order. Accordingly, when multiple images in a HEIF file all correspond to common metadata, or when two or more of the multiple images correspond to common metadata, the processing load when performing batch processing on the images has been heavy.

In addition, when, for example, a single image is divided into tiles and each tile image is stored as a derivative image, defining metadata such as Exif data for each derivative image has been inefficient from the perspective of file generation load, file size, and the like. Exif is an acronym for Exchangeable image file format. In other words, even though the metadata (e.g., image size, color information, encoding information, and the like) is often common for each tile image, the metadata has conventionally been defined for each of the multiple (derivative) images, which is inefficient.

On the other hand, the information used when configurating metadata applied. (corresponding) to an image has only been capable of containing information about whether or not the metadata is mandatory. In other words, when applying a plurality of pieces of metadata to a single image, it has not been possible to select and apply a single piece of metadata from metadata of the same type. For example, when storing alternative text information, such as that defined in HTML specifications, or when attempting to store information corresponding to multiple languages, it is preferable to be able to selectively apply the text information for each language to the image. HTML supports multiple languages by storing the Longdesc information for retrieving information from other URIs, but when the information is to be closed and stored within an image file, it is necessary to store information corresponding to each language in the file. In this case, it has not been possible to select one piece of text information in multiple languages and apply the information to an image.

The present disclosure provides a technique for efficiently performing processing related to image file generation.

### SUMMARY OF THE INVENTION

As an exemplified aspect of the disclosure, an image file generation apparatus has the following configuration. That is, the image file generation apparatus is an apparatus for storing one or more images in an image file according to a predetermined image file format, and comprising: an obtainment unit configured to obtain a plurality of pieces of metadata to be stored in the image file; a grouping unit configured to group the plurality of pieces of metadata by a type of the metadata; and a storage unit configured to store, in the image file, the metadata that has been grouped.

Further features of the present invention will become apparent from the following description of exemplary embodiments with reference to the attached drawings.

### BRIEF DESCRIPTION OF THE DRAWINGS

FIG. 1 is a diagram illustrating the configuration of an image file generation apparatus according to a first embodiment.

FIG. 2 is a diagram illustrating the flow of processing of the image file generation apparatus according to the first embodiment.

FIG. 3 is a diagram illustrating an example of a file format according to an embodiment.

FIG. 4 is a diagram illustrating an example of Exif data according to an embodiment.

FIG. 5 is a diagram illustrating the configuration of an image file generation apparatus according to a second embodiment.

FIG. 6 is a diagram illustrating the flow of processing of the image file generation apparatus according to the second embodiment.

FIG. 7 is a diagram illustrating an example of the structure of an Item Property Association Group Box in an image file format according to an embodiment.

FIG. 8 is a diagram illustrating an example of the structure of an Item Property Association Box in an image file format according to an embodiment.

FIG. 9 is a diagram illustrating another example of the structure of an Item Property Association Box in an image file format according to an embodiment.

FIG. 10 is a diagram illustrating another example of the structure of an Item Property Association Group Box in an image file format according to an embodiment.

FIG. 11 is a diagram illustrating an example of the structure, of a Common Item Property Box in an image file format according to an embodiment.

FIG. 12 is a diagram illustrating an example of the structure of a Common item Property Group Box in an image tile format according to an embodiment.

FIG. 13 is a diagram illustrating an example of the structure of an item Property Box in an image file format according to an embodiment.

FIG. 14 is a diagram illustrating an example of an Item Reference Box in an image file format according to an embodiment.

FIG. 15 is a diagram illustrating an example of an Item Information Box in an image file format according to an embodiment.

FIG. 16 is a diagram illustrating another example of the structure of an Item Property Association in an image file format according to an embodiment.

FIG. 17 is a diagram illustrating an example of the structure of an Item Property To Group Property Box in an image file format according to an embodiment.

FIG. 18A is a diagram illustrating the flow of processing of an image file generation apparatus according to a third embodiment.

FIG. 18B is a diagram illustrating the flow of processing of the image file generation apparatus according to the third embodiment.

FIG. 19 is a diagram illustrating an example of the structure of an Accessibility Text Property Box in an image file format according to the third embodiment

FIG. 20 is a diagram illustrating an example of an Item Property Box in arr image file format according to the third embodiment.

FIG. 21 is a diagram illustrating another example of an Item Property Box in an image file format according to the third embodiment.

### DESCRIPTION OF THE EMBODIMENTS

Examples of embodiments of the present invention will be described hereinafter in detail with reference to the appended drawings. It should be noted that the configurations described in the following embodiments are merely examples, and that the present invention is not intended to be limited to the configurations described therein and illustrated in the drawings.

### First Embodiment

A first embodiment will describe an example in which common metadata is extracted and stored in an image file when the image file is generated.

Configuration of Image File Generation Apparatus 101

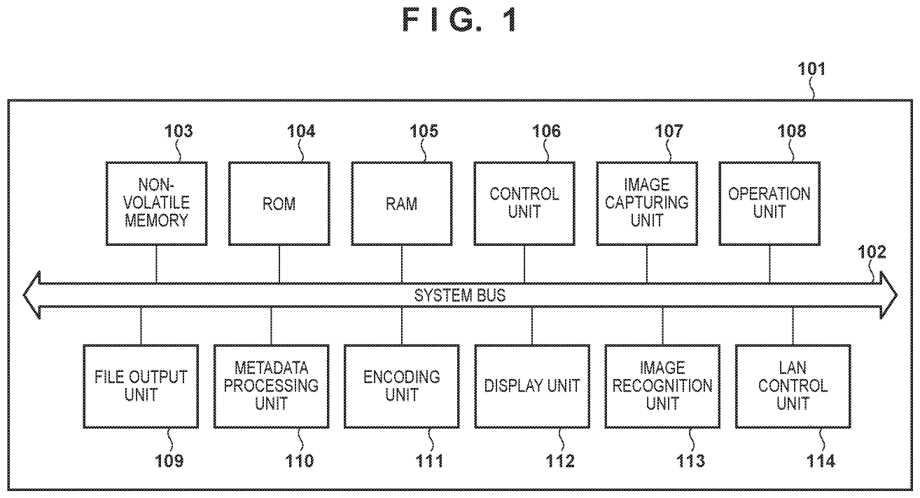

FIG. 1 illustrates the configuration of an image file generation apparatus 101 according to the present embodiment. The image file generation apparatus 101 illustrated in FIG. 1 is a communication apparatus having an image shooting function, such as a camera, a smartphone, a tablet PC, or the like. The image file generation apparatus 101 according to the present embodiment generates an image file compliant with a predetermined image file format. The image file generation apparatus 101 includes a system bus 102, as well as non-volatile memory 103, ROM 104, RAM 105, a control unit 106, an image capturing unit 107, and an operation unit 108. The image file generation apparatus 101 further includes a file output unit 109, a metadata processing unit 110, an encoding unit 111, a display unit 112, an image recognition unit 113, and a LAN control unit 114, and the hardware configuration is such that each of the aforementioned blocks is connected to the system bus 102. The system bus 102 transfers data among the blocks connected thereto. Although the term “image” is mainly used in the present embodiment, this is not intended to be limited to still images.

The control unit 106 is constituted by one or more CPUs, and executes programs stored in the ROM 104. The programs executed by the control unit 106 include an OS (operating system), drivers, applications, and the like. The control unit 106 controls the image file generation apparatus 101 as a whole by executing the programs. For example, the control unit 106 performs processing such as controlling the display unit 112 to make displays, instructing the image capturing unit 107 to shoot an image, instructing the LAN control unit 114 to make connections, and the like on the basis of instructions entered by a user through the operation unit 108. The image capturing unit 107 includes an image sensor such as a CMOS sensor or the like, and inputs image signals in response to instructions from the control unit 106. The input image signals are encoded into digital data by the encoding unit 111. The image file generation apparatus 101 may also have a function for decoding image files. For example, the control unit 106 causes a decoding unit (not shown) to decode an image file and display the decoded image data in the display unit 112 in response to a user operation pertaining to playback processing, made through the operation unit 108.

The metadata, processing unit 110 obtains the data encoded by the encoding unit 111 and generates an image file compliant with a predetermined file format (e.g., HEIF). Note, however, that the metadata processing unit 110 can generate a file compliant with, for example, another moving image file format defined by MPEG, a format such as JPEG, or the like, as opposed to being limited to HEIF. Additionally, the metadata processing unit 110 may generate the image file by obtaining encoded data from another apparatus instead of the encoding unit 111.

The file output unit 109 outputs the image file generated by the metadata processing unit 110. Although the output destination is not particularly limited, the image file may be output to a display device that displays an image on the basis of the image file, a printing device that prints an image based on the image file, or the like. Additionally, the image file may be output to a storage device that stores image files, or a storage medium that stores image files (the non-volatile memory 103). The non-volatile memory 103 is an SD card, CompactFlash (registered trademark), flash memory, or the like. The image recognition unit 113 executes processing for recognizing a person, an object, a scene, or the like in an image signal input from the image capturing unit 107, an image file stored in the non-volatile memory 103. or the like, and sends a result thereof (scene information, subject information, or the like) to the control unit 106. The control unit 106 sends instructions to the display unit 112, instructs the image capturing unit 107 to automatically activate a shutter, and the like on the basis of the result of the recognition processing. The control unit 106 also performs processing such as communicating metadata stored in the image file to the metadata processing unit 110. Note that in the present embodiment, “metadata” is essentially synonymous with “property information”.

Although each function block is configured as an individual circuit in the present embodiment, the processing (operations) of at least one function block may be realized by the control unit 106 or the like executing a program.

The RAM 105 is a main storage unit of the image file generation apparatus 101, and is mainly used as a temporary storage area for data when the processing of each function block is executed. The ROM 104 is anon-volatile storage unit in which software programs executed by the function blocks are stored. The programs stored in the ROM 104 are transferred to the RAM 105 and are executed having been read out by the function blocks. The LAN control unit 114 is a communication interface that connects to a LAN, and executes communication control for a wired LAN or a wireless LAN. When, for example, the image file generation apparatus 101 connects to another apparatus over a wired LAN, the LAN control unit 114 includes PHY and MAC (Transmission Media Control) hardware circuitry for transmission media. In this case, the LAN control unit 114 corresponds to an Ethernet (registered trademark) NIC (Network Interface Card). Meanwhile, when the image file generation apparatus 101 connects to another apparatus over a wireless LAN, the LAN control unit 114 includes a controller, RF circuitry, and antennas for executing wireless LAN control according to IEEE 802.11a/b/g/n/ac or the like.

Flow of Processing

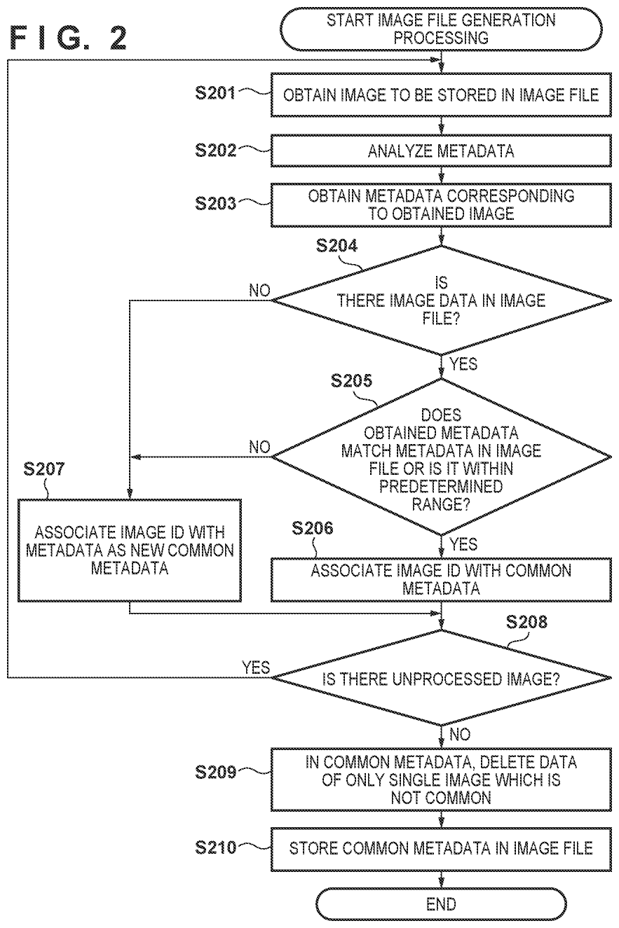

The flow of processing for generating an image file compliant with an image file format (HEIF) (that is, an HEIF file) will be described next with reference to FIG. 2. FIG. 2 is a diagram illustrating the flow of the processing for generating an image file according to the present embodiment. This processing flow can be executed by the circuits illustrated in FIG. 1, in response to a user operation. Alternatively, this processing flow can be realized by the control unit 106 executing programs stored in the ROM 104 at appropriate times, and computing and processing information, as well as controlling each instance of hardware.

In S201, the image file generation apparatus 101 obtains an image to be stored in an HEIF file. Specifically, the image signal obtained by the image capturing unit 107 is encoded by the encoding unit 111, and the encoded image signal (digital data) is input to the metadata processing unit 110. Note that the image file generation apparatus 101 can obtain image signals corresponding to a plurality of images. For example, when the image capturing unit 107 has shot a burst of images (continuous shooting), the plurality of images shot continuously are obtained. Additionally, when an image shot using the image capturing unit 107 is encoded by the encoding unit 111 haying been divided into tiles, the resulting tile images are obtained as a plurality of images. A method that uses tile encoding defined in HEVC, a method that individually encodes each of divided regions, and other methods can be used as the method for dividing an image into tiles and encoding the images, and the method is not limited. Additionally, the image file generation apparatus 101 can also obtain one or more images from another apparatus instead of the image capturing unit 107.

In S202, the metadata processing unit 110 analyzes metadata of the encoded image signal. Next, in S203, the metadata processing unit 110 obtains (extracts) the metadata corresponding to the image obtained in S201. A case where the metadata processing unit 110 obtains an image file compliant with ISOBMFF (ISO Base Media File Format) as the encoded image signal will be described here as an example. In this case, the metadata processing unit 110 obtains property information stored in an item Property Box (iprp), property information referenced by an item in an Image Property Association Box, and the like in the image file.

When, for example, an image file including Exif data has been obtained as the encoded image signal, the metadata processing unit 110 obtains the Exif data. Note that this data is not limited to Exif data, and may be XMP (Extensible Metadata Platform) metadata, MPEG-7 metadata, or the like, it is also acceptable for some of the Exif data. to be obtained in S203, for example.

A case where image information recognized by the image recognition unit 113 is handled as metadata. is also conceivable. For example, the image recognition unit 113 may recognize things such as what kind of scene an image depicts, whether a specific object is present in the image, and the like, and may input a result of the recognition (a scene recognition result, subject information, or the like) to the metadata processing unit 110 as the metadata. Metadata based on a result of such recognition processing can also be handled as common metadata, which will be described later.

In S204, the metadata processing unit 110 determines whether one or more images are already stored in the HEIF tile. If so, the sequence moves to 5205, and if not, the sequence moves to S207. In S205, the metadata processing unit 110 determines whether the metadata already stored in the HEIF file matches the metadata corresponding to the image obtained this time, or whether the metadata is within a predetermined range. If the metadata matches or in within the predetermined range, the sequence moves to S206, where the metadata processing unit 110 stores an item ID of the image obtained this time (image identification information) in association within the metadata already stored in the HEIF file (i.e., the common metadata). On the other hand, if the sequence has moved from S204 to S207, the metadata processing unit 110 stores the metadata of the image obtained this time as the common metadata in association with the item ID of the image obtained this time in a new HEIF file. Additionally, if the sequence has moved from S205 to S207, the metadata processing unit 110 stores the metadata of the image obtained this time as the common metadata in association with the item ID of the image obtained this time in an already-generated HEIF file.

Although all the metadata can be common metadata, whether to use only some of the metadata can be determined by making settings as desired. For example, it is acceptable to use only Exif data as common metadata, or only metadata in the Image Property Association Box as the common metadata, or only information on the shooting date/time as the common metadata.

In S208, the metadata processing unit 110 determines whether or not there are any unprocessed images. If there are no unprocessed images, the sequence moves to S209, whereas if there is an unprocessed image, the sequence moves to 5201. Note that the determination of S208 can be performed on the basis of shooting condition settings (e.g., a. number of shots in a burst), settings for the number of images made by the user, other predetermined conditions, or the like.

In S209, the metadata processing unit 110 deletes, from a common metadata storage region, metadata which is not common for two or more images. Although the present embodiment describes deleting metadata which is not common for two or more images, whether to delete the metadata may be determined using a threshold or the like aside from two. Furthermore, depending on the case, metadata corresponding only to a single image may be stored in the common metadata storage region. Such a configuration is useful, for example, when only a single image is stored in an HEIF file, in use cases where an image item in which specific metadata is recorded is to be retrieved quickly, and so on. In other words, the information stored in the common metadata storage region can be used as an index of images with which specific metadata is associated.

Next, in S210, the metadata processing unit 110 stores the common metadata in the HEIF file, Note that the common metadata may be stored in the HEIF file in S206 or S207 instead, If the metadata of each image will no longer be necessary as a result of storing the common metadata in the HEIF file, the metadata processing unit 110 deletes that metadata. from the HEIF file. For example, when Item Property Associations have been grouped, the Item Property Associations for each item are no longer necessary and are therefore deleted.

Example of Configuration of HEIF File Format

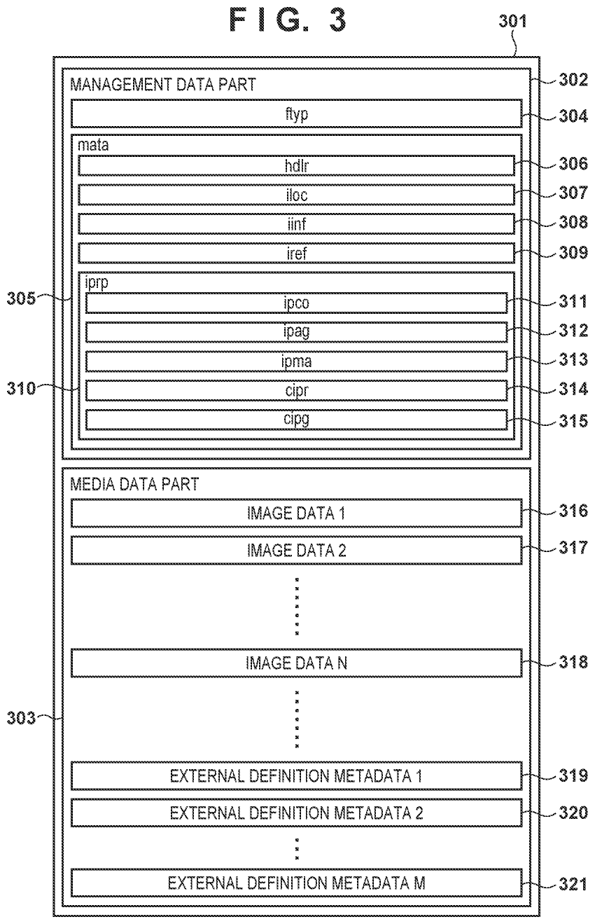

An example of the configuration of the format of the HEIF file generated by the image file generation apparatus 101 will be described next with reference to FIG. 3. FIG. 3 is a diagram illustrating an example of the format of the HEIF file.

An HEIF file 301, which is a typical file having a simple configuration, is constituted by a management data part 302 and a media data part 303. File management data, including information pertaining to the encoding of media data, information pertaining to the method of storage in the HEIF file, and the like, is stored in the management data part 302. Data obtained by encoding content data (moving images, still images, and audio) (hat is, media data), metadata. referring to an external standard, and the like are stored in the media data part 303. Encoded images, Exif data, and the like are stored in a box called a Media Data Box in the media data part 303. Storage regions 316, 317, and 318 indicate storage regions for each of images, and storage regions 319, 320, and 321 indicate storage regions for metadata defined by an external standard such as Exif data.

The management data part 302 has a box structure, and each box is identified by a type identifier. A box 304 is a File Type Box identified by an identifier “ftyp”. The File Type Box is used to identify the type of the file, and the file format is identified by a four-character identifier called a “brand”. HEIF files are represented using four-character identifiers that identify the brand, such as “mifl” and “msfl”. A box 305 is called a Meta Box, and is identified by an identifier “meta”. Various additional boxes are stored within the box 305 (Meta Box). For example, a box that stores images (image items), untimed metadata such as metadata items related to the images (image items), and the like are included in the box 305 (Meta Box). A box 306 is called a Handler Reference Box, and is identified by an identifier “hldr”. The structure, format, and the like of content in the box 305 (Meta Box) is identified by a handler type in the Handler Reference Box. In. the HEIF file, a four-character identification code called “pict” is applied to this handler type. A box 307 is called an Item Location Box, and is identified by an identifier “Hoc”. Information indicating an ID of each time (identification information of each image), a storage location (location), and the like is denoted in the box 307 (Item Location Box). By referring to this information, the metadata processing unit 110 can know where the data for the items defined in the management data part 302 are present. A box 308 is called an Item Information Box, and is identified by an identifier “iinf”. An Item Information Entry is defined for each item in the box 308 (Item Information Box), and information such as the item ID, an item type, an item name, and the like are stored in this entry.

A box 309 is called an Item Reference Box, and is identified by an identifier “iref”. The box 309 (Item Reference Box) stores information such as a reference type pertaining to the association of an item in a referential relationship. When the configuration is such that a single item reference a plurality of items, the referenced item IDs are denoted in order. For example, when a thumbnail image of item 1 is item 2, “thmb”, which indicates the thumbnail image as the reference type, is stored, with an item ID indicating item 1 stored in “from_item_id” and an item ID indicating item 2 stored in “to_item_id”. Additionally, when a single image is divided into a plurality of tiles and stored in the HEIF file, information indicating the relationships thereof is stored in the box 309 (Item Reference Box). For example, assume that the overall image is item 1, and the plurality of tile images are item 2, item 3, item 4, and item 5, In this case, information indicating that item 1 is an image formed by item 2, item 3, item 4, and item 5 is stored. Specifically, “dimg”, which indicates “derivative image”, is stored as the reference type, and an ID indicating item 1 is stored in from_item_id. Furthermore, all the item IDs indicating item 2, item 3, item 4, and item 5 are stored in to_item_id. Information for reconstructing a single image from a plurality of image items obtained by dividing the image into tiles is expressed in this way. A referential relationship between metadata defined by an external standard such as Exif data and the image items can also be denoted in the box 309 (Item Reference Box). In this case, “cdsc” is used as the reference type, an item ID indicating the Exif data is stored in from_item_id, and an item ID indicating the image item is stored in the to_item_id.

A box 310 is called an Item Property Box, and is identified by an identifier “iprp”. Property information applied to each item. boxes indicating methods for configuring the properties, and the like are stored in the box 310 (Item Property Box). A box 311 is called an Image Property Container Box, and is identified by an identifier “ipso”. Boxes that denote each property are stored in the box 311. The box 311 (Image Property Container Box) includes a variety of boxes, and for example, a box indicating the image size, a box indicating color information, a box indicating pixel information, a box storing HEVC parameters, and the like are stored as necessary. These file formats are common with the box structure specified in ISO/IEC 23008-12.

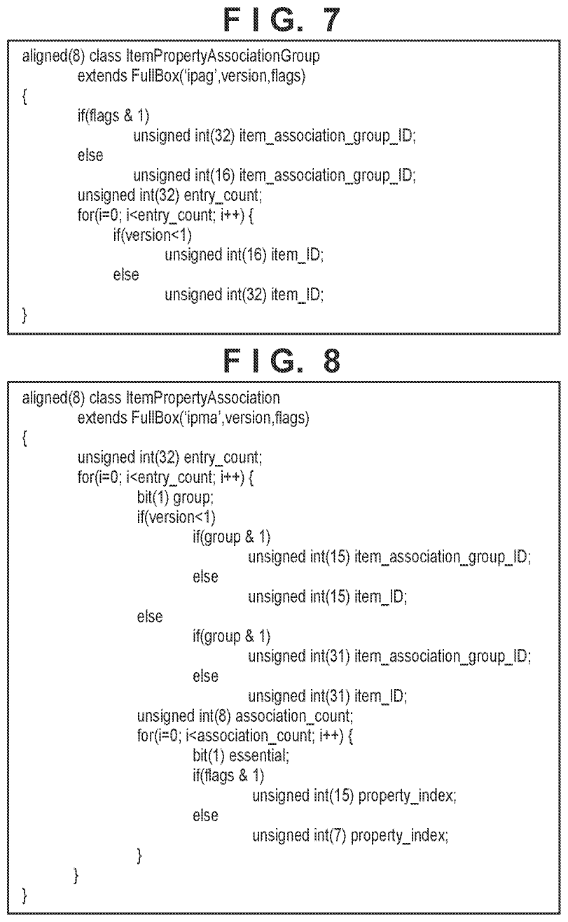

A box 312 is called an Item Property Association Group Box, and is identified by an identifier “ipag”. The box 312 (Item Property Association Group Box) is defined by the structure illustrated in FIG. 7. FIG. 7 is a diagram illustrating an example of the structure of the Item Property Association Group Box in the file format. The box 312 is a box for grouping item Property associations for each item defined in the entries of an Hem Property Association Box specified in ISO/IEC 23008-12. By using this item Property Association Group Box, items to which common item properties are applied can be grouped. The resulting item group can be identified by an item_association_group_id.

A box 313 is called an Item Property Association Box, and is identified by an identifier “ipma”. The box 313 is defined by the structure illustrated in FIG. 8. FIG. 8 is a diagram illustrating an example of the structure of the Item Property Association Box in the image file format. When denoting the configuration of item properties for each item, a “group” bit is set to 0, and the indexes of the properties applied to the items are denoted in order. On the other hand, for items grouped using the Item Property Association Group Box, the “group” bit is set to 1 to make it clear that the property configuration for the item group is denoted. The property configurations applied to the group identified by the item_association_group_id are then denoted in order. By doing so, items to which common properties are applied can be grouped and denoted, as opposed to the conventional structure in which all item configurations are denoted for each item. This makes it possible to reduce the amount of data used to denote the file format.

Note that the present embodiment defines the new box illustrated in FIG. 7, However, a method of grouping and denoting the items in the same manner may be employed by using the Entity To Group Box defined in ISO/IEC 23008-12 and extending the box illustrated in FIG. 8 accordingly.

With the box structure described in the present embodiment with reference to FIG. 7, the structure makes it possible to reduce the number of bits used, which in turn makes it possible to associate metadata with images efficiently. On the other hand, using the existing Entity To Group Box can also achieve the goal of defining groupings for items. A grouping_type is newly defined in this case. The present embodiment describes groupings pertaining to item properties, and thus uses a configuration in which the grouping of items within the Item Property Box is defined.

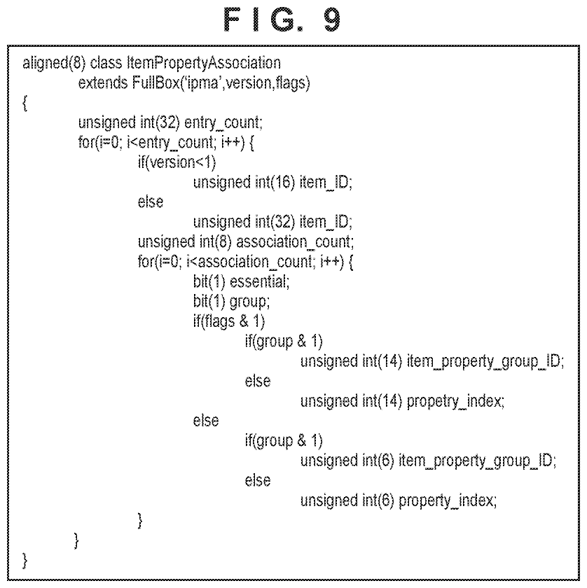

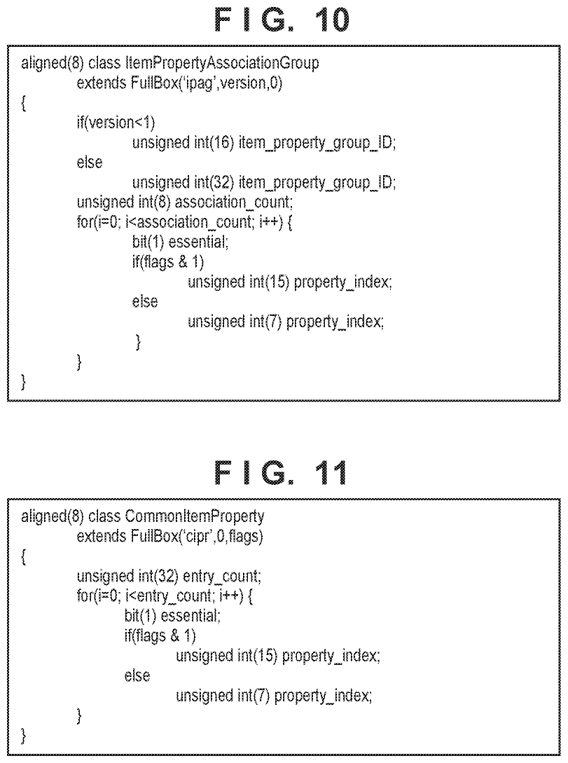

Although the present embodiment has described a method of efficiently denoting the item configuration through the foregoing method, the box structures illustrated in FIG. 9 and FIG. 10 may be employed as variations. FIG. 9 is a diagram illustrating another example of the structure of the Item Property Association Box in the image file format, and FIG. 10 is a diagram illustrating another example of the structure of the Item Property Association Group Box in the image file format. This is a method which does not group items, but rather groups and denotes the item properties to be applied to an image. In other words, with this method, some of the property information denoted for each item is described as a property group. Although not denoted in the box structure illustrated in FIG. 10, an identifier indicating the type to be grouped may be defined and stored as well. The identifier indicating the group type at this time is identified by using a value, such as ‘join’, Which indicates that the properties are to be combined and applied to all images. Although not described in detail here, this makes it possible to apply property groups aside from common properties. At this time, a four-character code indicating the group type may be stored instead of “ipag” indicated in the box type, or the group type may be defined as one of the structure members and stored. Additionally, although the box structure illustrated in FIG. 10 is defined in the Item Property Box in the present embodiment, the box structure may be defined in a Group List Box, specified in ISO/IEC 23008-12. This makes it possible to reduce the amount of data When denoting the file format.

Additionally, the box structure illustrated in FIG. 17 may be stored as one of item property boxes defined in an Item Property Container Box. FIG. 17 is a diagram illustrating an example of the structure of an Item Property To Group Property Box in the image file format, The box illustrated in FIG. 17 is the Item Property To Group Property Box, and is equivalent to the Item Property Association Group Box described above. Storing this box as one Item Property in the Item Property Container Box makes it possible to group the item properties and apply those properties to an image without changing the structure of the Item Property Association Box. With this box, an identifier indicating the type of the group can be stored in a four-character code identifying the box type. This makes it possible to determine to which type of group the item properties correspond. “num_properties_ in_group” indicates the number of item properties that are grouped. Additionally, “essential” information indicates whether or not the item properties indicated by each property_index are essential. Note that the “essential” information in the Item Property Association Box when index information indicating the Item Property To Group Property Box is stored in the Item Property Association Box is information indicating whether or not the item group itself is necessary. The information of item properties indicated by the index order starting from I in the Item Property Container Box is denoted in property_index, in the same manner as in the Item Property Association Box. Index number 0 is “reserved”. Although the Item Property To Group Property Box itself is expressed in the same index order, information indicating its own index order must not be stored in this box. If its own index is stored, that index is ignored. This makes it possible to avoid infinite loops. Because this box is defined as one of the item properties, the property type is a Descriptive type. Additionally, although it is desirable that each item property grouped in the list by the property_index be grouped separately by Descriptive type and Transformative type, the configuration is not limited thereto. In this case, after denoting the Descriptive-type item properties, the Item Property To Group Property Box that groups the Descriptive types is denoted. It is more desirable to denote Transformative item properties thereafter, and then denote the Item Property To Group Property Box, which groups the Transformative-type item properties. Note that the configuration may be such that whether a group is the Descriptive type or the Transformative type can be identified using the grouping_type or flags in the Item Property To Group Property Box.

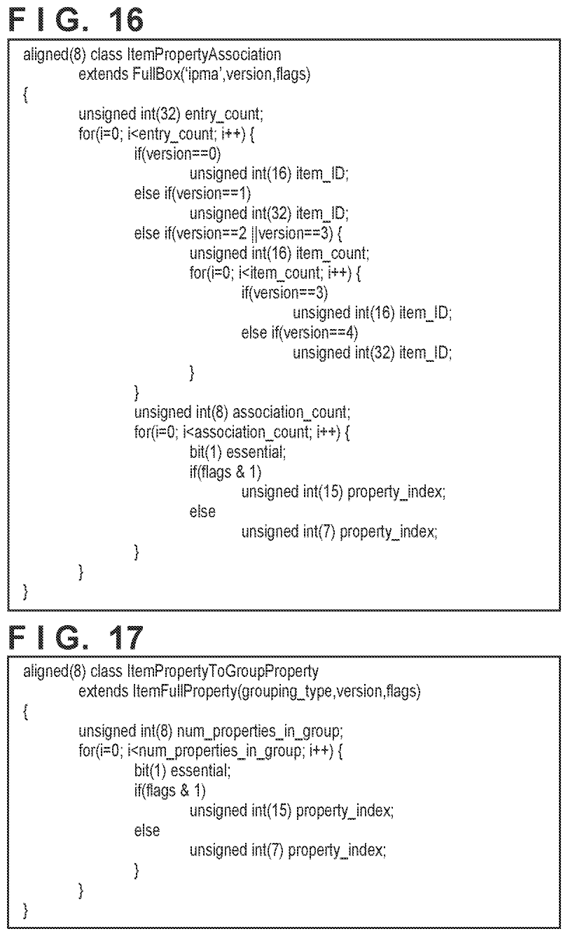

The present embodiment makes it possible to reduce the amount of data denoted in an image file by defining the box structure described above. However, a different box structure may be used as long as it provides a method for grouping and defining metadata (properties) applied to two or more items (image items). A data structure treated as an entry in a box may also be defined and stored as a different box. This other box structure may be, for example, the box structure illustrated in FIG. 16. FIG. 16 is a diagram illustrating another example of the structure of the Item Property Association Box in the image file format, According to the box structure illustrated in FIG. 16, a plurality of item properties can be applied to a plurality of items. In other words, items can be grouped within each entry in the Item Property Association Box, and the properties to be applied thereto can be denoted, without explicitly grouping item properties, items, and so on.

A box 314 is called a Common Item Property Box, and is identified by an identifier “cipr”. The box 314 is defined by the structure illustrated in FIG. 11. FIG. 11 is a. diagram illustrating an example of the structure of the Common Item Property Box. The box 314 (Common Item Property Box) is a box for indicating item properties applied in common to all items. By using the box 314, the properties (metadata) applied in common to all items are extracted with ease, In other words, using the box 314 to store the common metadata makes it possible to extract the common metadata without searching all the entries in the Item Property Association Box. This improves the search efficiency when accessing files.

The present embodiment describes an example in which the search efficiency is improved by defining a box that indicates properties applied in common to all the items. However, the configuration is not limited to this example, and it is also possible to store information that can be identified as applying to all such items in the box for each item property defined in the Item Property Container Box.

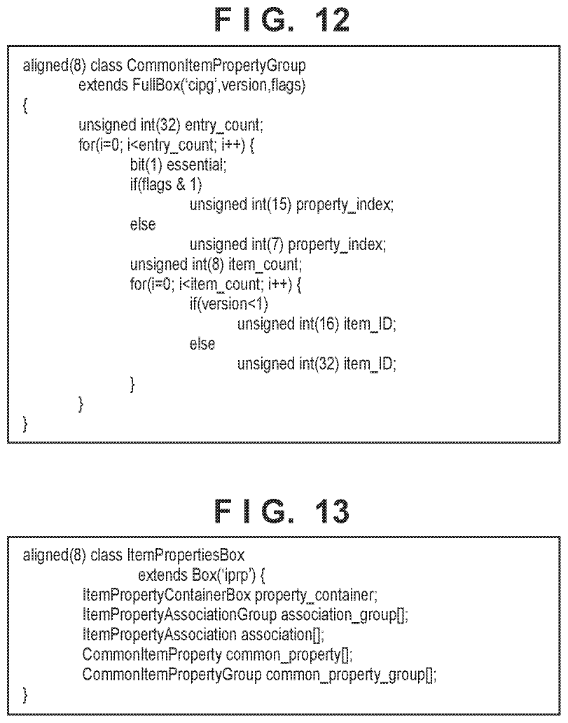

A box 315 is called a Common Item Property Group Box, and is identified by an identifier “cipg”, The box 315 is defined by the structure illustrated in FIG. 12. FIG. 12 is a. diagram illustrating an example of the structure of the Common Item Property Group Box. The box 315 (Common Item Property Group Box) is a box that makes it possible to identify items to which common properties (metadata) are applied. In other words, the box 315 (Common Item Property Group Box) is a box denoting a list of items to which common properties are applied. By using the box 315, the metadata processing unit 110 can identify the items to which specific properties are applied without confirming all of the entries in the Item Property Association Box. Furthermore, using the box 315. the efficiency can be improved when loading an image file and processing only items to which specific properties are applied, which in turn improves the search efficiency when accessing files. Using the box 315 also makes batch operations easier when editing files and the like. For example, when an item property indicated by property_index is a property indicating the image size, image items of the same size can be grouped together and denoted. By using the box 315 to express a plurality of image items to which other image properties defined in the item Property Container Box are applied as well makes it possible for the metadata processing unit 110 to easily identify a plurality of images to which common properties are applied.

The box 310 (Item Property Box) for storing the boxes expressing the common properties has the structure illustrated in FIG. 13. FIG. 13 is a diagram illustrating an example of the structure of the Item Property Box (Item Properties Box). The box 310 (Item Property Box) specifically stores the item Property Association Box in the item Properties Box identified by identifier “iprp”. The Item Property Container Box, Item Property Association Group Box, Common Item Property Box, and Common Item Property Group Box are stored as well.

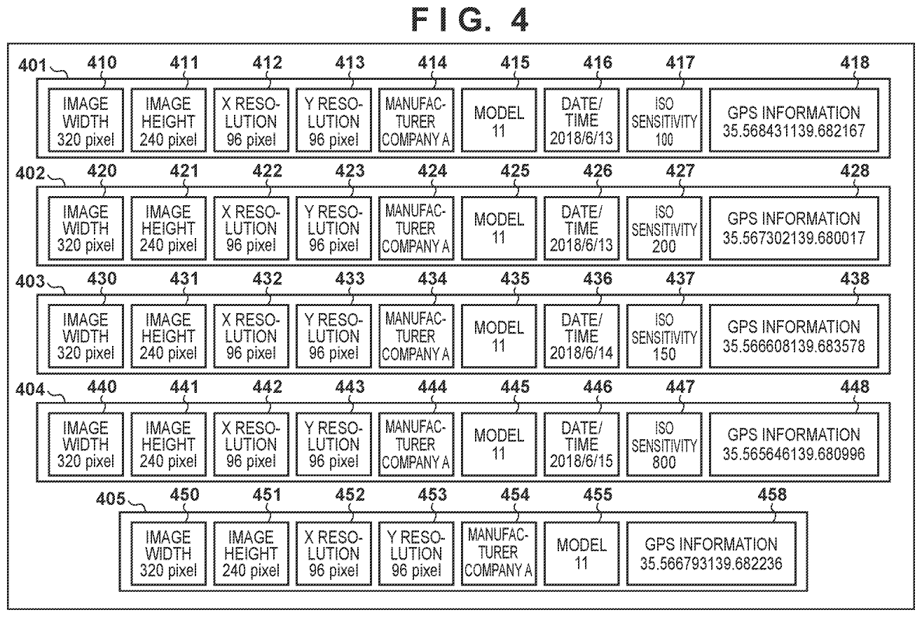

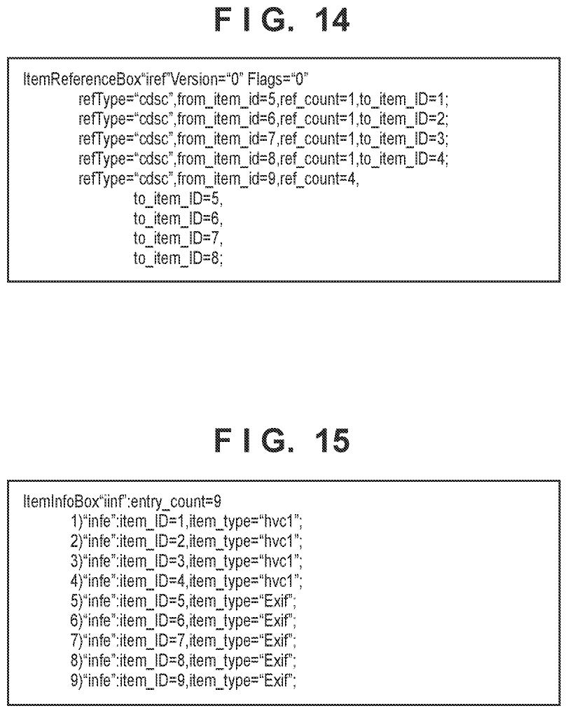

A method for storing, as the common metadata, external definition metadata (e.g., Exif data) indicated by each of the storage regions (boxes) 319, 320, and 321 stored in the media data part 303, will be described next with reference to FIG. 14, FIG. 15, and FIG. 4. FIG. 14 is an example of the details denoted in the box 309 (Item Reference Box) in FIG. 3. FIG. 15 is an example of the details denoted. in the box 308 (Item Information Box) in FIG. 3. FIG. 4 illustrates Exif data blocks 401, 402, 403, 404, and 405. The Item Information Box illustrated in FIG. 15 is constituted by nine entries, and item_IDs 1, 2, 3, and 4 indicate image items. An image item having an item_ID of 5 corresponds to an Exif data block 401, an image item having an item_ID of 6 corresponds to an Exif data block 402, an image item having an item_ID of 7 corresponds to an Exif data block 403, an image item having an item_ID of 8 corresponds to an Exif data block 404, and an image item having an item_ID of 9 corresponds to an Exif data block 405. The Item Reference Box illustrated in FIG. 14 indicates the referential relationship of each item. It can be seen from FIG. 14 and FIG. 15 that item_ID 5 is the Exif data block pertaining to an image having the item_ID of 1. Similarly, item_ID 6 is the Exif data block pertaining to an image having the item_ID of 2, and item_ID 7 is the Exif data block pertaining to an image having the item_ID of 3, Additionally, item_ID 8 is the Exif data block pertaining to an image having the item_ID of 4. Furthermore, item_ID 9 references item_IDs 5, 6, 7, and 8. These details indicate that item_ID 9 is an Exif data block obtained by extracting a common part (common metadata) from the Exif data blocks having the item_IDs 5, 6, 7, and 8.

The Exif data block 401 illustrated in FIG. 4 has Exif tags (metadata) for image width 410, image height 411, X resolution 412, Y resolution 413, manufacturer name 414, model name 415, shooting date/time 416, ISO sensitivity 417, and GPS information 418. The same applies to the Exif data blocks 402, 403, and 404. These tags are generated when the image is captured. Tags may also be added, changed, or deleted through separate editing processing or the like. The Exif data block 405 is a block that stores common data (common metadata) of the Exif data blocks 401. 402, 403, and 404. The values indicated by image widths 410, 420, 430, and 440 are common, i.e., “320 pixels”, and thus a value of “320 pixels” is stored in an image width tag 450 in the Exif data block 405. Likewise, the values indicated by image heights 411, 421, 431, and 441 are common, i.e., “240 pixels”, and thus a value of “240 pixels” is stored in an image height tag 451 in the Exif data block 405. “96 dpi” indicated by X resolutions 412, 422, 432, and 442 is stored in a region 452. “96 dpi” indicated by Y resolutions 413, 423, 433, and 443 is stored in a region 453. “Company A” indicated by manufacturer names 414, 424, 434, and 444 is stored in a region 454. “11” indicated by model names 415, 425, 435, and 445 is stored in a region 455.

On the other hand, the shooting date/time differs depending on the image. In the example illustrated in FIG. 4, (shooting) date/time 416 and 426 are “Jun. 13, 2018”, date/time 436 is “Jun. 14, 2018”, and date/time 446 is “Jun. 15, 2018”. As such, the shooting date/time is not stored in the Exif data block 405 obtained by extracting the common data of the Exif data blocks. In this manner, in the example illustrated in FIG. 4. only metadata common for all of the image items is stored in the Exif data block 405. Additionally, because ISO sensitivities 417 427, 437, and 447 also have different values, these are not stored in the Exif data block 405. Note that time information is omitted from date/time 416, 426, 436, and 446 in FIG. 4.

However, in the example illustrated in FIG. 4, GPS information 418, 428, 438, and 448, which are location information, need not have perfectly-matching values, and are stored in the Exif data block 405 as long as the values fall within a predetermined range. This is because the GPS information 418, 428, 438, and 448 are a match for a specific location, even if not a perfect match. In other words, the GPS information 418, 428, 438, and 448 all indicate the location of Company A, and all locations derived by geocode or the like match as Company A.

Accordingly, the metadata processing unit 110 according to the present embodiment handles a plurality of pieces of GPS information falling within a predetermined range as common metadata. In this manner, some types of metadata (e.g., GPS information) can be stored in the region for storing common metadata even if the values do not match exactly. The range of what is considered common can be specified separately by the user, or can be determined as appropriate according to the settings and the like of the specific system. hi the example illustrated in FIG. 4, all GPS information from within the premises of Company A is treated as common metadata, and the GPS information stored in GPS information 458 expresses a representative point of Company A, represented by a geocode or the like. For example, when GPS information within the Tokyo metropolitan area is treated as common GPS information, the location information of a representative point of Tokyo will be stored in the GFS information 458. Although the HEIF file according to the present embodiment does not store information indicating the granularity at which the GPS information is handled, such information may be stored in the file.

FIG. 4 illustrates an example in which data common to all Exif data blocks for each image is stored in a common Exif data block. However, an Exif data block common to two or more Exif data blocks may be stored in a common Exif data block. In that case, the Exif data block to be referenced may be defined in the Item Reference Box indicated in FIG. 14. For example, when extracting an Exif data block common for only item_ids 5 and 6, 5 and 6 are stored in to_item_ID. In such a case, the (shooting) date/time 416 and 426 are also common Exif data and are therefore extracted. There may be a plurality of Exif data blocks to be extracted as common Exif data blocks, and the source data to be extracted may overlap, such as data common to item_IDs 5 and 6, and the data common to item IDs_5, 6, 7, and 8.

Additionally, although the metadata processing unit 110 according to the present embodiment extracts all the data that is common in the Exif data block corresponding to each image, it is also possible to extract the data that is common only for specific Exif data. For example, whether or not only the shooting date/time are common may be subject to the determination. For example, the commonality of the shooting date/time may be determined only for images for which the shooting date/time falls within a specific certain range. Thus it should be noted that the commonality may be determined only for a specific type of metadata, and there are many variations in terms of how to determine the specific type,

As described thus far, the image file generation apparatus 101 according to the present embodiment extracts common metadata from metadata (property information) associated with each of a plurality of images stored in an image tile (HEIF file) compliant with an image file format. The image file generation apparatus 101 then stores the extracted metadata in a metadata region as common metadata. The image file generation apparatus 101 may also store, in the HEIF file, information indicating whether the common metadata is common to all images, or the common metadata is only common to some of the plurality of images. If the common metadata is common only to some of the images, the item IDs (image identification information) of the stated some of the images are stored. For metadata based on an external standard (e.g., Exif data), the image file generation apparatus 101 also extracts common metadata from the metadata for each image, and holds that metadata as common metadata. This makes it possible to reduce the processing load when handling a plurality of images stored in an HEIF file. For example, the processing load can be reduced when specific processing is performed on only one or more images associated with specific metadata among the plurality of images stored in the HEIF file. Additionally, processing for searching for a specific image among the plurality of images stored in the HEIF file can be performed at a low load. Furthermore, storing metadata made common for each image makes it possible to reduce the size of the image file.

### Second Embodiment

The first embodiment mainly described an example in which common metadata is extracted and stored in an image file when the image file is generated. A second embodiment, described hereinafter, will describe, in detail, an example of extracting common metadata from images, metadata, and the like already stored in an image file.

Configuration of image File Generation Apparatus 501

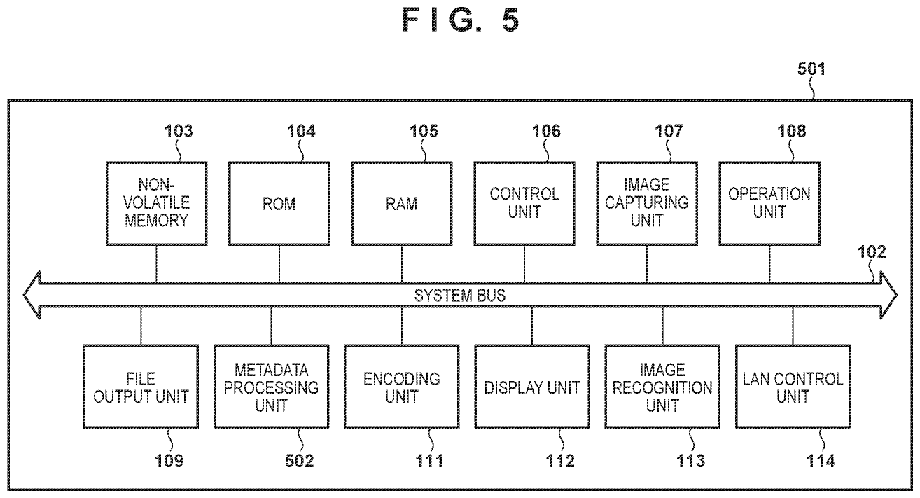

FIG. 5 illustrates the configuration of an image file generation apparatus 501 according to the present embodiment. The image file generation apparatus 501 illustrated in FIG. 5 is a communication apparatus having a file editing function, such as a tablet PC, a desktop PC, a server device that performs processing using a web service in the cloud, or the like. Constituent elements having the same reference signs as in FIG. 1 are the same as in FIG. 1 and will therefore not be described. A metadata processing unit 502 performs processing for editing an image file and extracting common metadata from an image, metadata, and the like already stored in the image file. The image file generation apparatus 501 according to the present embodiment has a characteristic of editing the image file, and may therefore be configured without the image capturing unit 107.

Flow of Processing

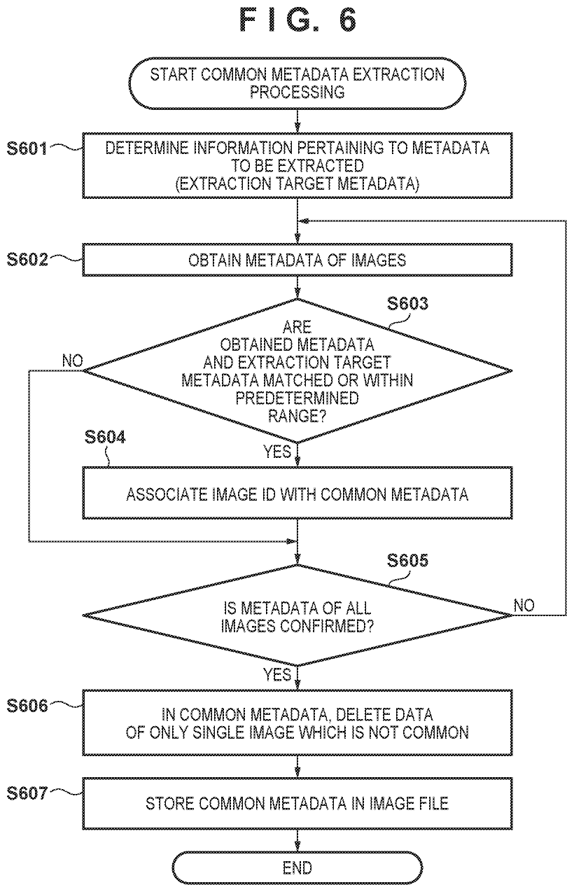

The flow of processing for extracting common metadata from an image file compliant with an image file format (an HEIF file) (that is, editing processing) will be described next with reference to FIG. 6. FIG. 6 is a diagram illustrating the flow of processing of the image file generation apparatus 501 according to the second embodiment. This processing flow can be executed by the circuits illustrated in FIG. 5, in response to a user operation. Alternatively, this processing flow can be realized by the control unit 106 executing programs stored in the ROM 104 at appropriate times, and computing and processing information, as well as controlling each instance of hardware. It is assumed that one or more image files compliant with the image file format (HEIF files) are stored in the image file generation apparatus 501 in advance.

In S601, the metadata processing unit 502 determines information pertaining to the metadata to be extracted (extraction target metadata), such as the value, range, and type, on the basis of the metadata associated with each of a plurality of images stored in the HEIF file. This determination may be made on the basis of a user instruction made through the operation unit 108, or may be made on the basis of a system setting or the like set in advance. A plurality of determinations may also be made.

In S602, the metadata processing unit 502 obtains the metadata of each of the plurality of images stored in the HEIF file, The metadata processing unit 502 is not limited to a single HEIF file, and may process a plurality of HEIF files. The file is not limited to an HEIF file, and a REG file or the like may be processed as well. Furthermore, the metadata processing unit 502 may obtain only metadata which is already recorded in the HEIF file, or may obtain metadata and the like newly generated through processing performed by an image recognition unit 506.

Next, in S603, the metadata. processing unit 502 determines whether the metadata obtains in S602 and the extraction target metadata determined in S601 match. The sequence moves to S604 if the metadata match, and to S605 if not. Note that in S603, the metadata processing unit 502 may determine Whether or not the range of both pieces of metadata is within a predetermined range, with the sequence moving to S604 if so, and to S605 if not.

In S604, the metadata processing unit 502 extracts the matching metadata as common metadata, and stores the common metadata in a common metadata storage region in association with an item ID for identifying the image. When a plurality of image files are to be processed, the metadata processing unit 502 creates a new HEIF file and stores the image items and item IDs corresponding thereto in the file. In S605, the metadata processing unit 502 determines whether the processing is complete for all images for which the metadata is to be obtained. If so, the sequence moves to S606, and if not, the sequence moves to S602 and the processing is repeated.

In S606, the metadata processing unit 502 deletes metadata, among the extracted common metadata, which is not common with other images. In other words, the metadata processing unit 502 does not stored metadata applied to only a single image as the common metadata. Next, in S607, the metadata processing unit 502 stores the common metadata in the HEIF file, At this time, the metadata processing unit 502 stores the common metadata in the HEIF file in accordance with the format illustrated in FIG. 7 to FIG. 17, on the basis of the common metadata and the item ID of the image. Although the present embodiment describes not storing metadata corresponding to only a single image as the common metadata, it is also possible to not store metadata common with a number of images lower than a predetermined threshold as the common metadata. Furthermore, depending on the case, metadata corresponding only to a single image may be stored in the region for storing the common metadata. Such a configuration is useful, for example, when only a single image is stored in an HEIF file, in use cases where an image item in which specific metadata is recorded is to be retrieved quickly, and so on. In other words, the information stored in the common metadata storage region can be used as an index of images with which specific metadata is associated.

As described thus far, the image file generation apparatus 501 according to the present embodiment extracts common metadata from an image file that has already been generated and newly generates an HEIF file in which that common metadata is stored. This makes it possible to generate an image file storing common metadata from an image file in which common metadata is not recorded. Additionally, the image file generation apparatus 501 according to the present embodiment extracts common metadata from a plurality of images (including video) stored in a plurality of image files (including video files) and newly generates an image file in which the common metadata is stored.

Through this, a single HEIF file can be generated, through editing processing, from image files generated by a plurality of apparatuses, image files generated under different conditions, and the like. At this time, information indicating whether the common metadata is common for the entire image group or is common for only some of the image group may be stored as well, as described in the first embodiment. If the common metadata is common for only some images, the item IDs of the images corresponding to the common metadata are stored as well. For metadata based on an external standard (e.g., Exif data), the image file generation apparatus 101 also extracts common metadata from the metadata for each image, and holds that metadata as common metadata. This makes it possible to reduce the processing load when handling a plurality of images stored in an HEIF file. For example, the processing load can be reduced when specific processing is performed on only one or more images associated with specific metadata among the plurality of images stored in the HEIF file. Additionally, processing. for searching for a specific image among the plurality of images stored in the HEIF file can be performed at a low load. Furthermore, storing metadata made common for each image makes it possible to reduce the size of the image file.

### Third Embodiment

The first embodiment and the second embodiment mainly described an example in which common metadata is extracted and stored in an image file. The following third embodiment will describe an example in which the metadata of the same type is grouped, applied to the same image, and stored. When the image file generation apparatus according to the present embodiment is an apparatus having an image shooting function, the configuration is the same as that illustrated in FIG. 1. When metadata of the same type as an image, metadata, and the like already stored in the image file is additionally stored, the configuration is the same as that illustrated in FIG. 5.

Flow of Processing

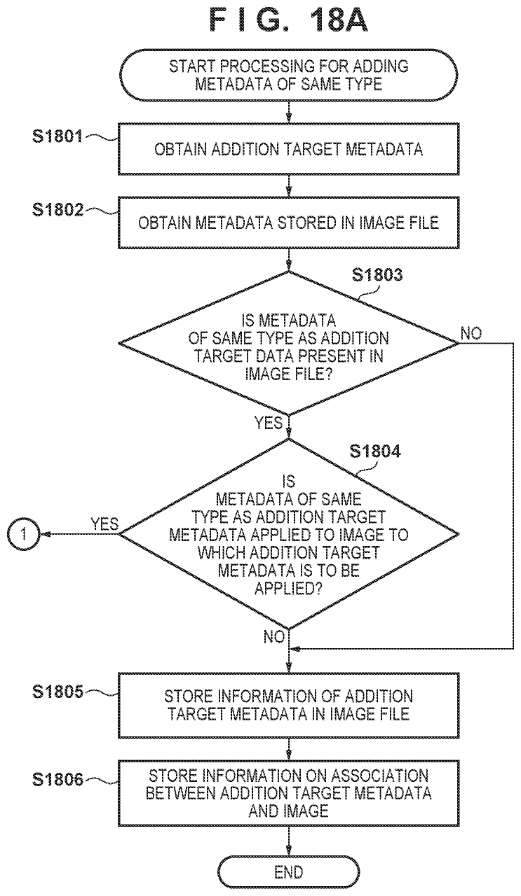

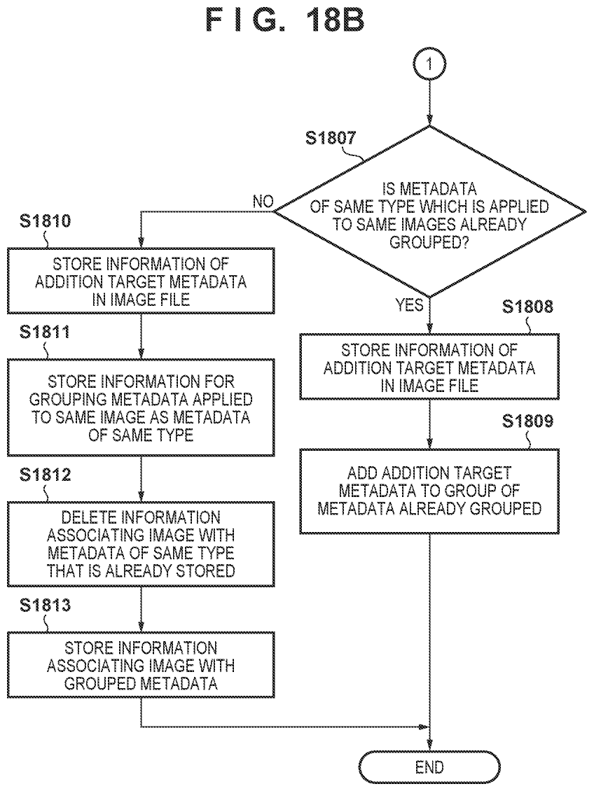

The flow of processing for adding metadata of the same type to an image file compliant with an image file format (an HEIF file) will be described next with reference to FIG. 18A and FIG. 18B. FIG. 18A and FIG. 18B are diagrams illustrating the flow of the processing for generating an image file according to the present embodiment. This processing flow is typically started in response to the input of an editing instruction from the user. For descriptive purposes, this processing flow is assumed to be performed by the image file generation apparatus 501 illustrated in FIG. 5. For example, this processing flow can be realized by the circuits illustrated in FIG. 5. or by the control unit 106 executing programs stored in the ROM 104 at appropriate times and computing and processing information, as well as controlling each instance of hardware, in response to a user operation. It is assumed that one or more image files compliant with the image file format (HEIF files) are stored in the image file generation apparatus 501 in advance. Additionally, an image to which the metadata to be added (addition target metadata, described later) can be applied is assumed to already be present in the HEIF file.

In S1801, the metadata processing unit 502 obtains the metadata to be stored in the HEIF file (the addition target metadata). The metadata processing unit 502 may obtain the addition target metadata on the basis of a user instruction made through the operation unit 108, or may obtain the metadata on the basis of system settings or the like set in advance.

In S1802, the metadata processing unit 502 obtains one or more pieces of metadata stored in the HEIF file, and obtains the type of each piece of metadata. Details regarding the types of the metadata will be given later. Next, in S1803, the metadata processing unit 502 determines whether metadata of the same type as the addition target metadata obtained in S1801 is present in the HEIF file. In other words, the metadata processing unit 502 determines whether there is a type, among the types of the one or more of the pieces of metadata obtained in S1802, that matches the type of the addition target metadata obtained in S1801. If so, the sequence moves to S1804, and if not, the sequence moves to S1805. This determination can be performed on the basis of a knowledge base or the like, such as a dictionary, stored in the image file generation apparatus 501 in advance. Additionally, the comparison may be made with other information, such as the properties, attributes, or the like of the metadata, instead of the type of the metadata.

In S1801, the metadata processing unit 502 confirms whether metadata of the same type as that determined to be present in S1803 is currently applied to an image to which the addition target metadata is to be applied (the image to which the addition target metadata is applied). If so, the sequence moves to S1807, and if not, the sequence moves to S1805. Note that when there are a plurality of images to which the addition target metadata is to be applied, the metadata processing unit 502 performs the confirmation for each image, and the sequence moves to S1807 if the metadata is to be applied to even one of the images.

In S1805, the metadata processing unit 502 stores the information of the addition target metadata in the HEIF file. This mainly corresponds to storing the information as the Item Property in an element of the Item Property Container Box. Next, in S1806, the metadata processing unit 502 stores association information on the association between the stored addition target metadata and the image (the image to which the addition target metadata is applied), and then ends the processing. This mainly corresponds to storing association information for each image item in the Item Property Association Box. In particular, the metadata processing unit 502 stores an index order of the Item Property Container Boxes for the item properties in association with the respective item IDs.

In S1807, after a determination of “Yes” is made in S1804, the metadata processing unit 502 confirms whether the metadata of the same type, applied to the same image, is already grouped. If metadata of the same type is already grouped, the sequence moves to S1806. If not, the sequence moves to S1810. Even if pieces of the metadata. are of the same type, if the pieces of metadata are selectively not applied and are instead applied with different meanings, the pieces of metadata are not considered to be of the same type, and the sequence therefore moves to S1810.

In S1808, the metadata processing unit 502 stores the information of the addition target metadata in the HEIF file, in the same manner as in S1805. In S1809, the metadata processing unit 502 adds information of the addition target metadata stored in S1808 to a group of metadata already grouped, and ends the processing. Through this, an option is added in a group of item properties that are already associated with image items in the Item Association Box.

In S1810, after a determination of “Yes” is made in S1807, the metadata processing unit 502 stores the information of the addition target metadata in the HEIF file, in the same manner as in S1805 and S1808. In S1811, the metadata processing unit 502 stores information for grouping the metadata applied to the same image as metadata of the same type. In other words, the metadata processing unit 502 stores information for grouping, as metadata of the same type, the metadata applied to the image to which the addition target metadata is to be applied, and the addition target metadata. In S1812, the metadata processing unit 502 deletes the information associating the image item with metadata of the same type that is already stored. Specifically, this corresponds to deleting the corresponding index information in the item properties within the Item Association Box. In S1813, the metadata processing unit 502 stores information associating the grouped metadata with the image item. Specifically, this corresponds to storing association information indicating an item property group in the Item Association Box.

The foregoing makes it possible to selectively apply properties (metadata) to be applied to an image from among a plurality of properties (selectively associating from among a plurality of properties as properties related to an image). Although the present embodiment describes a flow in which metadata of the same type as an image, metadata, or the like already stored in an image file is added and stored, the configuration may be such that properties of the same type are grouped and stored during the image file generation processing performed through the flow illustrated in FIG. 2. At this time, when an image to be stored in the image file format is input in S201, metadata group information of the same type is stored when storing related metadata. In addition, although the present embodiment describes grouping properties using the above-described box structure, any box structure that can achieve this purpose may be used.

Example of Configuration of Item Property Group Box

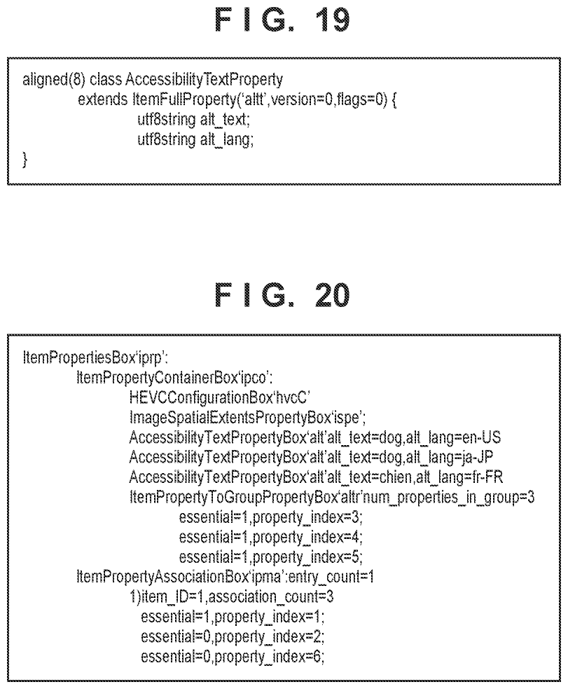

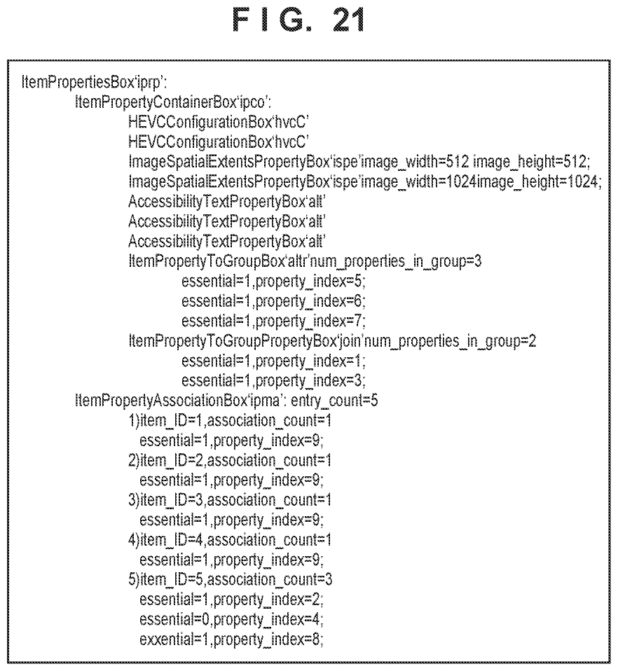

An example of application to an image when storing item properties (metadata) as an item property group will be described with reference to FIG. 19, FIG. 20, and FIG. 21. FIG. 19 is a diagram illustrating an example of the structure of an Accessibility Text Property Box, and FIG. 20 and FIG. 21 illustrate examples of an Item Property Box.

The box illustrated in FIG. 19 is the Accessibility Text Property Box. This box is a box that stores information on alternative text strings in the HTML specification. The “alt_text” stored in this box is a parameter that stores the alternative text of the HTML specification. In addition, “alt_lang” stores an identifier indicating a language using a Character string for a language tag compliant with RFC4646, BCP47, or the like, such as “en-US”, “fr-FR”, “zh-CN”, and “ja-JP”. The text information of the language indicated by alt_lang is stored in alt_text. Using this box makes it possible to store text information indicating what content an image item has and the like. Furthermore, storing this box as item properties for each language to be stored makes it possible to store text information corresponding to each language. Although the present embodiment describes storing alternative text according to the HTML specification, the text information may be stored without being limited to the HTML specification.

The Item Properties Box illustrated in FIG. 20 illustrates an example of item properties stored in an image file being applied to an image. This image file stores four subpictures, having item IDs 1 to 4, and one image item, having item ID 5, that constitutes a derivation image of a grid of the subpictures. Each of the four subpictures has a width of 512 and a height of 512, and the single image that is the derivation image thereof stores an image that has a width of 1024 and a height of 1024. Common properties are applied to the four subpictures, and the one derivative image stores text information on what the image is an image of (indices 1 to 6).

Specifically, the Item Property Container Box and the Item Property Association Box are stored in the Item Properties Box. In addition, six pieces of various item properties are stored in the Item Property Container Box.

The first box, an HEVC Configuration Box, is a box indicated by an identifier “hvcC”, and stores encoding parameters of the image item. The second box, an Image Spatial Extents Property Box, is a box indicated by an identifier “ispe”, and stores information indicating the size of the image.

The third to fifth boxes, which are Accessibility Text Property Boxes, are boxes having the structure illustrated in FIG. 19, and are identified by “altt”. The Accessibility Text Property Box that is the third box stores “en-US” in alt_lang, indicating English in the US region. The “alt_text” stores the English character string “dog”. Likewise, the Accessibility Text Property Box that is the fourth box stores “ja-JP” in alt _lang, indicating Japanese in the Japan region. The “alt_lang” stores a Japanese character string corresponding to “dog”. Likewise, the Accessibility Text Property Box that is the fifth box stores “fr-FR” in alt_lang, indicating French in the France region. The “alt text” stores the French character string “chien”. These three Accessibility Text Property Boxes all store character strings having the same meaning in their respective languages. In other words, the type, as the meaning of the text information associated with the same image, is the same. As described above, it is assumed that the image file generation apparatus 501 (or 101) has a knowledge base such as training data or a dictionary stored in advance, and can determine whether or not the type of the metadata is the same.

The sixth box, the Item Property To Group Property Box, is a box indicated by an identifier “ipma”, as illustrated in FIG. 17. Using this box, the Accessibility Text Property Boxes that are third, fourth, and fifth in the index order of the Item Property Container Box are grouped as item properties of the same type. Specifically, the item properties are grouped as item properties of the same type, using a grouping type of “altr”. num_properties_in_group indicates 3, which indicates that three item properties are grouped. In addition, the “essential” information indicates that the item properties are essential (1=essential). The property_index, which is the index order of the Item Property Container Box, indicates “3, 4, and 5”, and thus the aforementioned Accessibility Text Property Boxes are grouped. In this manner, the three Accessibility Text Property Boxes are grouped using the Item Property To Group Property Box, and can be grouped and applied to items using the Item Property To Group Property Box.

Next, the Item Properly Association Box is a box indicated by an identifier “ipma”, and stores information indicating the relationships between each image item and the item properties. entry_count indicates 1, which indicates that the item property association of one image is stored. association_count indicates that an image having an item_ID of 1 is associated with three item properties. “Essential” indicates 1, which indicates that the property is essential. The property_index of 1 indicates that the HEVC Configuration Box described above, which is first in the index order of the Item Property Container Box, is associated. Next, the second entry indicates 0 for “essential”, which indicates that the property is not essential. The property_index of 2 indicates that the aforementioned Image Spatial Extents Property Box is associated. Next, the third entry indicates 0 for “essential”, which indicates that the property is not essential. The property_index indicates 6, and thus the Item Property To Group Property Box is associated. This makes it possible for a device reading an image file to reference an image item for which the Item Property To Group Property Box is applied with a group type “alar” by selecting one of the three Accessibility Text Property Boxes.

Although the present embodiment describes a configuration in which any one of the item properties grouped by “altr” is selectively applied to an image item, a plurality of properties may be selectively applied. Additionally, although the present embodiment describes a configuration in which the item properties are explicitly grouped and applied to the image item using the Item Property To Group Property Box, if the same type of item properties have been applied to the item Property Association Box, the item properties may be implicitly and selectively applied to the image item. In addition to alternative text information, related text may be stored as labels. In this case, it is also possible to apply a plurality of pieces of text information grouped according to meaning, and selectively apply label information to each group. Although only the Descriptive type is denoted in FIG. 20, Transformative-type item properties can be grouped in the same manner. At this time, it is desirable to group Descriptive-type and Transformative-type properties without mixing those properties. Also at this time, flags may be used to indicate what type of property is being grouped, and grouping_type may be used to define the group type in an identifiable manner. Also, by denoting a Descriptive-type group after denoting a Descriptive-type property, it is possible to denote a pre-described index number. Transformative-type item properties are denoted thereafter. In the same manner, it is more desirable to denote the Item Property To Group Property Box which groups the Transformative-type item properties. This makes it possible to apply the item properties without changing constraint conditions on the application

By explicitly grouping and applying properties to image items as in the present embodiment, it is possible not only to group different group types, but also to group a plurality of properties having the same type but different meanings and apply those properties to image items. This makes it possible to apply item properties of the same type, which have been applied with different meanings, to image items selectively, on a group-by-group basis.

Next, FIG. 21 illustrates an example of the Item Properties Box for an image file to which item groups of the same type of item properties, and common item properties, have been applied, respectively,

The Item Property Container Box and the Item Property Association Box are stored. in the Item Properties Box. In addition, nine pieces of various item properties are stored in the Item Property Container Box. The first box, an HEVC Configuration Box, is a. box indicated by an identifier “hvcC”, and stores encoding parameters of the image item. The second box, an HEVC Configuration Box, stores different encoding parameters. The third and fourth boxes, Image Spatial Extents Property Boxes, are boxes indicated by an identifier “ispe”, and store information indicating the size of the image. The two Image Spatial Extents Property Boxes store information on different image sizes,

The fifth to seventh boxes, which are Accessibility Text Property Boxes, are boxes having the structure illustrated in FIG. 19, and are identified by “altt”. Text in mutually-different languages is stored in the three Accessibility Text Property Boxes. The Item Property To Group Property Box, identified by the group type “odtr”, groups three item properties. In the present embodiment, the Accessibility Text Property fifth, sixth, and seventh in index order are grouped as the same type of property. Additionally, the Item Property To Group Property Box, indicated by the group type “join” groups two item properties. In the present embodiment, the HEVC Configuration Box first in index order and the Image Spatial Extents Property Box third in index order are grouped as common item properties. Next, the Item Property Association Box stores property association information for five items. Items having item IDs from 1 to 4 have the “join” type item group ninth in index order applied thereto, and all item properties first and third in index order are applied in common. Also, for an item having an item ID of 5, the item properties second, fourth, and eighth in index order are applied. The eighth item property in the index order is selectively applied from the fifth, sixth, and seventh item properties in index order in the “altr”-type item property group.

Although the present embodiment has been described by defining the Accessibility Text Property Box as an item property of the same type, other different item properties may be selectively applicable. For example, when the same item property has a plurality of versions, each of the different versions may be stored as the same kind of property and applied as a box having the version supported by a readout device. In addition, 16:9, 4:3, or other sizes of cropping can be enabled by applying a plurality of Clean Aperture Boxes, identified by “clap”, and selecting the readout device. In addition, it is possible to define a Clean Aperture Box for each of a plurality of specific people, and the readout device can selectively display only the specific people. A variety of other extensions are also conceivable.

As described thus far, the image file generation apparatus 101 or 501 according to the present embodiment extracts common metadata or metadata of the same type among a plurality of pieces of metadata (property information) related to an image stored in an image file compliant with an image file format (an HEIF file). The extracted metadata is then grouped and stored in the metadata region. At this time, an identifier that makes it possible to determine the type that has been grouped is stored. The grouped metadata is associated with the image in the same way as other ungrouped metadata, and is held in the image file. This makes it possible to handle a plurality of pieces of metadata. (property information) stored in an HEIF file as a group, which reduces the processing load when handling images and makes it possible to apply the metadata selectively. This selective application makes it possible to handle images adaptively on the basis of circumstances, conditions, and decisions of the device reading out the image file. Furthermore, storing metadata. made common for each image makes it possible to reduce the size of the image file.

Thus according to the embodiment described above, when two or more images among a plurality of images stored in an image file according to a predetermined image format correspond to common metadata, processing pertaining to that image file can be performed efficiently. Additionally, when applying, to a single image, two or more of the same type of metadata among the plurality of pieces of metadata stored in an image file according to a predetermined file format, the metadata can be selectively applied to that image tile.

According to the present invention, processing pertaining to image file generation can be performed efficiently.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiments) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image file generation apparatus for storing one or more images in an image file according to a predetermined image file format, the apparatus comprising:
an obtainment unit configured to obtain a plurality of pieces of metadata to be stored in the image file;
a grouping unit configured to group the plurality of pieces of metadata by a type of the metadata; and
a storage unit configured to store, in the image file, the metadata that has been grouped.

2. The image file generation apparatus according to claim 1, wherein
the grouping unit groups metadata applied to a same image and having a same type, and the storage unit stores the grouped metadata in the image file in association with the same image.

3. The image file generation apparatus according to claim 2, wherein
the grouping unit groups metadata having a same type as a meaning of text information related to the same image.

4. The image file generation apparatus according to claim 3, wherein
the grouping unit groups a plurality of pieces of metadata having a same meaning for the text information and expressed in different languages.

5. The image file generation apparatus according to claim 1, wherein
the grouping unit groups metadata having a type that is common for two or more images, and the storage unit stores the grouped metadata in the image file in association with the two or more images.

6. The image file generation apparatus according to claim 1, wherein
the obtainment unit obtains the plurality of pieces of metadata on the basis of an input made by a user or a setting made in advance.

7. The image file generation apparatus according to claim 1, further comprising:
an output unit configured to output the image file to an exterior.

8. The image file generation apparatus according to claim 1, wherein
the predetermined image file format is a format defined in ISO/TEC 23008-12.

9. The image file generation apparatus according to claim 8, wherein
the obtainment unit obtains metadata of an image file compliant with an ISO Base Media File Format as the metadata, and
the grouping unit extracts property information stored in an Item Property Box from the image file compliant with the ISO Base Media File Format and performs grouping on the basis of a result of the extraction.

10. An image file generation method for storing one or more images in an image file according to a predetermined image file format, the method comprising:
obtaining a plurality of pieces of metadata to be stored in the image file;
grouping the plurality of pieces of metadata by a type of the metadata; and
storing, in the image file, the metadata that has been grouped.

11. A non-transitory computer-readable storage medium that stores a program that causes a computer included in an image file generation apparatus for storing one or more images in an image file according to a predetermined image file format to:
obtain a plurality of pieces of metadata to be stored in the image file;
group the plurality of pieces of metadata by a type of the metadata; and
store, in the image tile, the metadata that has been grouped.
